(19) United States
(12) Patent Application Publication
(10) Pub. No.: US 2026/0289037 A1
(43) Pub. Date: Sep. 24, 2026

(54) POROUS TUBE CELL, POROUS TUBE STRUCTURE, AND METHOD FOR DESIGNING SAME

(71) Applicant: SOUTHWEST JIAOTONG UNIVERSITY, Chengdu City (CN)

(72) Inventors: Hu LIU, Chengdu City (CN); Junyi LIU, Chengdu City (CN); Zhengqiang CHENG, Chengdu City (CN); Qianhua KAN, Chengdu City (CN); Guozheng KANG, Chengdu City (CN)

(73) Assignee: SOUTHWEST JIAOTONG UNIVERSITY, Chengdu City (CN)

(21) Appl. No.: 19/191,217

(22) Filed: Apr. 28, 2025

(30) Foreign Application Priority Data
Mar. 19, 2025 (CN) 202510323842.9

(51) Int. Cl. G06F 30/20; G06F 30/10; G06F 119/14

(52) U.S. Cl. CPC G06F 30/20; G06F 30/10; G06F 2119/14

(57) ABSTRACT

A porous tube cell, a porous tube structure and a method for designing the same are provided. The porous tube cell includes two circumferential structures, two radial structures, an intermediate structure and a plurality of connecting rods. The circumferential structure includes a plurality of circumferential units. The radial structure includes a plurality of radial units. A circumferential structure, a radial structure, another circumferential structure and another radial structure are arranged in sequence around the intermediate structure and connected by the connecting rods to form a frame structure. An angle between a first diagonal brace and a first vertical rod is different from an angle between a second diagonal brace and a second vertical rod. An angle between a third diagonal brace and a third vertical rod is different from an angle between a fourth diagonal brace and a third vertical rod.

### CROSS-REFERENCE TO RELATED PRESENT DISCLOSURE

This patent application claims the benefit and priority of Chinese Patent Application No. 202510323842.9 filed with the China National Intellectual Property Administration on Mar. 19, 2025, the disclosure of which is incorporated by reference herein in its entirety as part of the application.

### TECHNICAL FIELD

The present disclosure relates to the technical field of Poisson's ratio structures, and in particular to a porous tube cell, a porous tube structure and a method for designing the same.

### BACKGROUND

A Poisson's ratio is a basic characteristic of materials. For materials with positive Poisson's ratio characteristics, the cross section perpendicular to the compression direction will expand under compression, and the cross section perpendicular to the tensile direction will shrink under tension. Materials with positive Poisson's ratio characteristics are strong in bearing capacity, but short in compression stroke and ordinary in vibration reduction. For materials with negative Poisson's ratio characteristics, the cross section perpendicular to the compression direction will shrink under compression, and the cross section perpendicular to the tension direction will expand under tension, which is high in energy absorption efficiency and excellent in vibration reduction, but low in strength. The traditional Poisson's ratio porous tube structure is usually cubic, which has the same Poisson's ratio in all directions. Moreover, a corresponding method for adjusting and designing a Poisson's ratio has not been established. It is impossible to adjust the Poisson's ratios in different directions as needed, and the application scope is small. Therefore, there is an urgent need for a porous tube cell, a porous tube structure, and a method for designing the same, in which the Poisson's ratios are different in a circumferential direction and a radial direction and can be adjusted in the design stage, so that the application range is wider.

### SUMMARY

The present disclosure aims to provide a porous tube cell, a porous tube structure and a method for designing the same, so as to solve the problems existing in the prior art. The Poisson's ratios of the porous tube structure are different in a circumferential direction and a radial direction, and can be adjusted in the design stage, so that the application range is wider.

In order to achieve the above objectives, some embodiments provide the following scheme.

The present disclosure provides a porous tube cell, including two circumferential structures, two radial structures, an intermediate structure and a plurality of connecting rods. The circumferential structure includes a plurality of circumferential units. The radial structure includes a plurality of radial units. A circumferential structure, a radial structure, another circumferential structure and another radial structure are arranged in sequence around the intermediate structure and connected by the connecting rods to form a frame structure. An angle between a first diagonal brace and a first vertical rod is different from an angle between a second diagonal brace and a second vertical rod. An angle between a third diagonal brace and a third vertical rod is different from an angle between a fourth diagonal brace and a third vertical rod.

The present disclosure further provides a porous tube structure and a method for designing a porous tube.

Compared with the prior art, some embodiments have the following technical effects.

The porous tube cell according to some embodiments can exhibit Poisson's ratio characteristics in the radial direction and the circumferential direction of the porous tube cell when stressed in the vertical direction. Moreover, changing the angle between the diagonal brace and the vertical rod in the design stage can allow the same porous tube cell to have different Poisson's ratios in the circumferential direction and the radial direction of the annular sector, thus making full use of the high strength of positive Poisson's ratio materials and the energy absorption characteristics of negative Poisson's ratio materials, and expanding the application scope of the porous tube structure.

### BRIEF DESCRIPTION OF THE DRAWINGS

In order to explain the embodiments of the present disclosure or the technical schemes in the prior art more clearly, the drawings that need to be used in the embodiments will be briefly introduced hereinafter. Obviously, the drawings in the following description are only some embodiments of the present disclosure. For those skilled in the art, other drawings can be obtained according to these drawings without paying creative labor.

FIG. 1 is a three-dimensional structural diagram of a porous tube cell according to some embodiments of the present disclosure.

FIG. 2 is a top view of a porous tube cell according to some embodiments of the present disclosure.

FIG. 3 is a schematic diagram of labeling parameters on the basis of FIG. 2.

FIG. 4 is a schematic diagram of labeling parameters on the basis of FIG. 1.

FIG. 5 is a three-dimensional structural diagram of a porous tube structure with a radial Poisson's ratio of 0.25 and a circumferential Poisson's ratio of −0.2.

FIG. 6 is a side view of a porous tube structure in FIG. 5.

FIG. 7 is a three-dimensional structural diagram of a porous tube cell forming a porous tube structure in FIG. 5.

FIG. 8 is a three-dimensional structural diagram of a porous tube structure with a radial Poisson's ratio of −0.25 and a circumferential Poisson's ratio of 0.2.

FIG. 9 is a side view of a porous tube structure in FIG. 8.

FIG. 10 is a three-dimensional structural diagram of a porous tube cell forming a porous tube structure in FIG. 8.

FIG. 11 is a three-dimensional structural diagram of a porous tube structure with a radial Poisson's ratio of 0.4 and a circumferential Poisson's ratio of 0.2.

FIG. 12 is a side view of a porous tube structure in FIG. 11.

FIG. 13 is a three-dimensional structural diagram of porous tube cells forming a porous tube structure in FIG. 11.

FIG. 14 is a three-dimensional structural diagram of a porous tube structure with a radial Poisson's ratio of −0.25 and a circumferential Poisson's ratio of −0.4.

FIG. 15 is a side view of a porous tube structure in FIG. 14.

FIG. 16 is a three-dimensional structural diagram of a porous tube cell forming a porous tube structure in FIG. 14.

FIG. 17 is a schematic diagram of an inner diameter, an outer diameter and a thickness of a cell bounding box.

In the figures: 1 circumferential unit; 11 first vertical rod; 12 first diagonal brace; 2 radial unit; 21 second vertical rod; 22 second diagonal brace; 3 intermediate frame; 31 third vertical rod; 32 third diagonal brace; 33 fourth diagonal brace; 4 connecting rod.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without paying creative labor belong to the scope of protection of the present disclosure.

The present disclosure aims to provide a porous tube cell, a porous tube structure and a method for designing the same, so as to solve the problems existing in the prior art. The Poisson's ratios are different in a circumferential direction and a radial direction, and can be adjusted in the design stage, so that the application range is wider.

In order to make the above objectives, features and advantages of the present disclosure more obvious and understandable, the present disclosure will be explained in further detail with reference to the drawings and the detailed description hereinafter.

### Embodiment 1

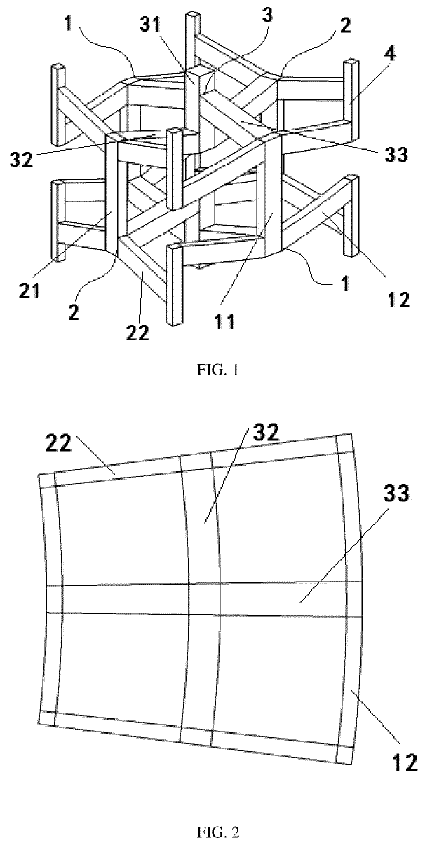

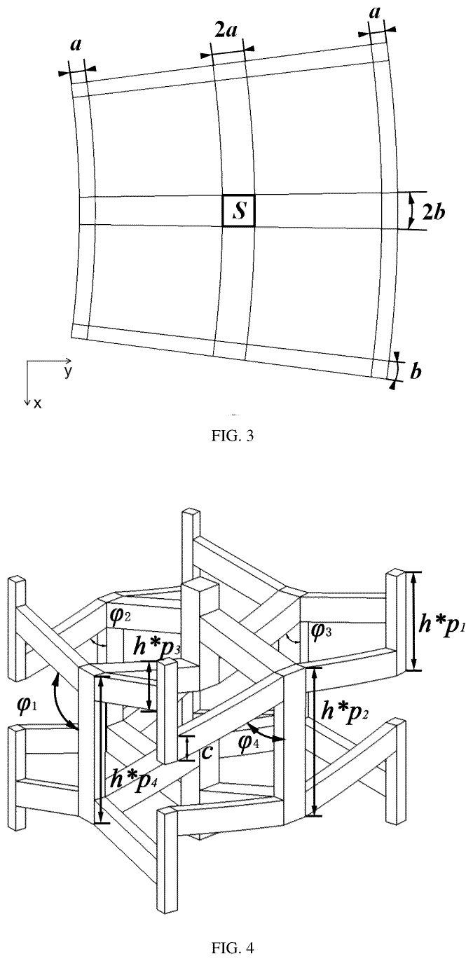

This embodiment provides a porous tube cell, as shown in FIG. 1 and FIG. 2, including two circumferential structures, two radial structures, an intermediate structure and a plurality of connecting rods 4. The circumferential structure includes a plurality of circumferential units 1. The circumferential unit 1 includes a first vertical rod 11 and four first diagonal braces 12. The four first diagonal braces 12 are arc-shaped rods. One end of the first vertical rod 11 is fixedly connected with one end of each of two first diagonal braces 12, and the other end of the first vertical rod 11 is fixedly connected with one end of each of the other two first diagonal braces 12. The radial structure includes a plurality of radial units 2. The radial unit 2 includes a second vertical rod 21 and four second diagonal braces 22. One end of the second vertical rod 21 is fixedly connected with one end of each of two second diagonal braces 22, and the other end of the second vertical rod 21 is fixedly connected with one end of each of the other two second diagonal braces 22. The intermediate structure includes a plurality of intermediate frames 3 arranged in sequence in a vertical direction. The intermediate frame 3 includes a third vertical rod 31, two third diagonal braces 32 and two fourth diagonal braces 33. One end of each of the two fourth diagonal braces 33 and one end of each of the two third diagonal braces 32 are fixedly connected with the third vertical rod 31. A circumferential structure, a radial structure, another circumferential structure and another radial structure are arranged in sequence around the intermediate structure and connected by the connecting rods 4 to form a frame structure. Each of the circumferential unit 1 forms an inner ring and an outer ring of the frame structure. Each of the radial units 2 extends in a radial direction of the frame structure. A projection of the frame structure on a plane perpendicular to the first vertical rod 11 in the vertical direction is an annular sector. An end of each of the third diagonal braces 32 away from the third vertical rod 31 is fixedly connected with the second vertical rod 12. An end of each of the fourth diagonal braces 33 away from the third vertical rod 31 is fixedly connected with the first vertical rod 11. One end of the connecting rod 4 is fixedly connected with an end of the first diagonal brace 12 away from the first vertical rod 11, and the other one end of the connecting rod 4 is fixedly connected with an end of the second diagonal brace 22 away from the second vertical rod 21. An angle between the first diagonal brace 12 and the first vertical rod 11 is different from an angle between the second diagonal brace 22 and the second vertical rod 21, and an angle between the third diagonal brace 32 and the third vertical rod 31 is different from an angle between the fourth diagonal brace 33 and the third vertical rod 31.

In the porous tube cell according to this embodiment, an angle between the first diagonal brace 12 and the first vertical rod 11 is different from an angle between the second diagonal brace 22 and the second vertical rod 21, and an angle between the third diagonal brace 32 and the third vertical rod 31 is different from an angle between the fourth diagonal brace 33 and the third vertical rod 31, which allows the structural rigidity and the deformation mechanism of the porous tube cell to be different in the radial direction and the circumferential direction, and also exhibits different Poisson's ratio characteristics in the radial direction and the circumferential direction (for example, the porous tube cell has positive Poisson's ratio characteristics in the circumferential direction and negative Poisson's ratio characteristics in the radial direction, and when the porous tube structure formed by the porous tube cell is vertically compressed, the perimeter of the porous tube structure increases and the wall thickness of the porous tube structure decreases). Moreover, the angle between the first diagonal brace 12 and the first vertical rod 11 and the angle between the third diagonal brace 32 and the third vertical rod 31 are changed in the design stage, so that the Poisson's ratio of the porous tube cell in the circumferential direction can be changed. The angle between the second diagonal brace 22 and the second vertical rod 21, and the angle between the fourth diagonal brace 33 and the third vertical rod 31 are changed, so that the Poisson's ratio of the porous tube cell in the radial direction can be changed. Therefore, the porous tube cell with different Poisson's ratios in the circumferential direction and the radial direction can be designed correspondingly in different use scenarios, thus making full use of the high strength of positive Poisson's ratio materials and the energy absorption characteristics of negative Poisson's ratio materials, and expanding the application scope.

In one embodiment of this embodiment, two circumferential units 1 and two radial units are provided, respectively.

In order to improve the stability of the porous tube cell, in one embodiment of this embodiment, the included angle between two of the first diagonal braces 12 connected with the same end of the first vertical rod 11 is ≥120° and <180°, or >180° and ≤240°, and an included angle between two of the second diagonal braces 22 connected with the same end of the second vertical rod 21 is ≥120° and <180°, or >180° and ≤240°.

In one embodiment of this embodiment, two intermediate frames 3 are provided.

### Embodiment 2

The porous tube structure according to this embodiment includes a plurality of circular tube assemblies, wherein the circular tube assembly includes a plurality of porous tube cells in Embodiment 1, each of the porous tube cells is fixedly connected in sequence along a circumferential trajectory in a horizontal plane, and the plurality of circular tube assemblies are fixedly connected in sequence in a vertical direction.

The porous tube structure according to this embodiment is spliced by a plurality of porous tube cells in Embodiment 1. The mechanical properties of the porous tube cell are able to be changed in the design stage, so that the spliced porous tube structure has different in-plane Poisson's ratios in the radial direction and the circumferential direction, and the application range of the porous tube structure is wider.

### Embodiment 3

First, it is to be noted that in this embodiment, except for the “cells with square cross-sections”, all other “cells” are the “porous tube cells” described in Embodiment 1.

This embodiment provides a method for designing a porous tube structure, including the following steps:
Step 1, determining an overall size of the porous tube structure and the number of the cells, and determining the size and the number of the cell bounding boxes according to the overall size of the porous tube structure;
Step 2, adjusting an angle between the first vertical rod 11 and the first diagonal brace 12, an angle between the third diagonal brace 32 and the third vertical rod 31, an angle between the second diagonal brace 22 and the second vertical rod 21, and an angle between the fourth diagonal brace 33 and the third vertical rod 31 in the cells;
Step 3, calculating a Poisson's ratio of the cells in a circumferential direction and a radial direction;
Step 4, arranging the cells to obtain a porous tube structure.

The method of designing the porous tube structure according to this embodiment can adjust the structure of the cell in the design stage, and obtain the porous tube structure with the same or different Poisson's ratios in the circumferential direction and the radial direction. The cell bounding box is a geometry encircled by splicing several virtual surfaces that are fitted to the side surface, the bottom surface and the top surface of the cell in order to calculate the size of the outline of the cell.

In an implementation of this embodiment, the Step 1 further includes: after determining the overall size of the porous tube structure, determining geometric parameters of the cell bounding box according to the following formula:
a radial thickness of the cell bounding box: T=(R−r)/Nᵣ;
an inner diameter of the cell bounding box:

$${R}_{1} = r + {\sum }_{i = 1}^{{N}_{r}} T ( i - 1 ) ;$$

an outer diameter of the cell bounding box:

$${R}_{2} = r + {\sum }_{i = 1}^{{N}_{r}} Ti ;$$

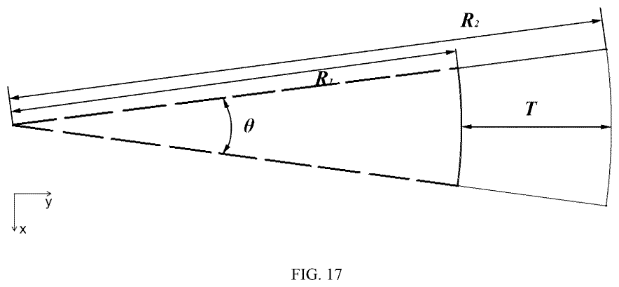

a central angle of the cell bounding box: θ=2π/N_{τ};
a height of the cell bounding box: h=H/N_{z};
where N_{τ} denotes the number of the cells in a circumferential direction of the porous tube structure, Nᵣ denotes the number of the cells in a radial direction of the porous tube structure, R denotes an outer diameter of the porous tube structure, r denotes an inner diameter of the porous tube structure, N_{z} denotes the number of stacked layers of the cells in an axial direction of the porous tube structure, H denotes a height of the porous tube structure, and i denotes an i-th layer of the cells in the radial direction of the porous tube structure. The positions represented by T, R₁ and R₂ are shown in FIG. 17.

In one embodiment of this embodiment, the Step 2 further includes: setting cross-sectional shapes of the first vertical rod 11, the second vertical rod 21, the third vertical rod 31 and the connecting rod 4 perpendicular to the respective length directions to be square, and keeping a relative position between geometric centers of the first vertical rod 1 and the first diagonal brace 12 unchanged, and a relative position between geometric centers of the second vertical rod 21 and the second diagonal brace 22 unchanged;

The geometric parameters of the cell bounding box obtained based on the Step 1 according to the following formulas are obtained:
a distance between the second vertical rod 21 and the connecting rod 4:

$$\frac{{R}_{1} - {R}_{2} - 4 a}{2} ;$$

an arc length between the first vertical rod 11 and the connecting rod 4 on the circumferential unit of an inner ring of the cell:

$$\frac{θ π {R}_{1}}{360} - 2 b ;$$

an arc length between the first vertical rod 11 and the connecting rod 4 on the circumferential unit of an outer ring of the cell:

$$\frac{θ π {R}_{2}}{360} - 2 b ;$$

a width of the third diagonal brace 32 in the radial direction of the cell: 2a=c=\sqrt{S};
an arc length of an end of the fourth diagonal brace 33 located at the outer ring of the cell in the circumferential direction of the outer ring of the cell:

$$2 b = \frac{4 a}{{R}_{1} + {R}_{2}} ;$$

defining 2p₁=p₂=p₄; and

$$\frac{c}{h} < {p}_{3} < {p}_{1} ;$$

where R₁ denotes an inner diameter of the cell bounding box, R₂ denotes an outer diameter of the cell bounding box, 6 denotes a central angle of the cell bounding box, S denotes a cross-sectional size of the third vertical rod in the horizontal direction, a denotes a width of the first diagonal brace in the radial direction of the cell, b denotes an arc length of the end of the first diagonal brace in the circumferential direction of the cell, c denotes a height of the first diagonal brace or the second diagonal brace, p₁, p₂, p₃ and p₄ are coefficients.

Using the above proportional relationship, S, p₁, p₂, p₃ and p₄ are defined, so that the angle between the first vertical rod 11 and the first diagonal brace 12, the angle between the third diagonal brace 32 and the third vertical rod 31, the angle between the second diagonal brace 22 and the second vertical rod 21, and the angle between the fourth diagonal brace 33 and the third vertical rod 31 are changed, and the Poisson's ratios of the cell in the radial direction and the circumferential direction are changed.

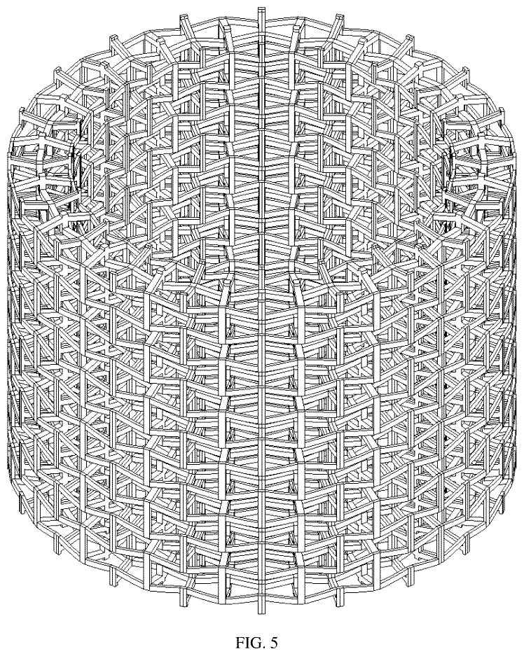

As shown in FIG. 4, p₁*h denotes a length of the connecting rod, p₂*h denotes a length of the first vertical rod, p₃*h denotes a vertical distance from the top of the connecting rod to the bottom of the first diagonal brace 12, and p₄*h denotes a length of the second vertical rod. In the process of adjusting the sizes of the first vertical rod 11, the second vertical rod 21 and the connecting rod 4, the changes of the sizes of the first vertical rod 11, the second vertical rod 21 and the connecting rod are only the extensions of the ends thereof. The purpose of defining 2p₁=p₂=p₄ is to ensure the consistency among cells, that is, allowing ⅛ cells to form the minimum repeating unit. The sizes of S, p₁, p₂, p₃ and p₄ are set according to the experience of designers.

In addition, the following content can also be calculated:
a volume of the cell: V_{cell}=2S[h(2p₁+p₂)+2(R₁−R₂)+(R₁+R₂)θ−8\sqrt{S}];
a volume of the cell bounding box:

$${V}_{box} = \frac{h θ}{2} ( {R}_{2}^{2} - {R}_{1}^{2} ) ;$$

a relative density of the cell: ρ_{cell}=V_{cell}/V_{box}.

In an implementation of this embodiment, the Step 3 further includes:
calculating an included angle as φ, in which the formulas are as follows:
an angle between the second diagonal brace 22 and the second vertical rod 21:

$${φ}_{1} = {tan}^{- 1} \frac{( {R}_{2} - {R}_{1} ) - 4 a}{h ( 2 {p}_{3} + {p}_{4} - 1 ) - 2 c}$$

an angle between the first diagonal brace 12 and the first vertical rod 11 on the circumferential unit of the inner ring of the cell:

$${φ}_{2} = {tan}^{- 1} \frac{2 {R}_{1} sin ( \frac{θ}{2} - 2 b )}{h ( 2 {p}_{1} + {p}_{2} - 1 ) - 2 c}$$

an angle between the third diagonal brace 32 and the second vertical rod 21:

$${φ}_{3} = {tan}^{- 1} \frac{( {R}_{1} + {R}_{2} ) sin ( \frac{θ}{2} - 2 b )}{h ( 2 {p}_{1} + {p}_{2} - 1 ) - 2 c}$$

an angle between the first diagonal brace 12 and the first vertical rod 11 on the circumferential unit of the outer ring of the cell:

$${φ}_{4} = {tan}^{- 1} \frac{2 {R}_{2} sin ( \frac{θ}{2} - 2 b )}{h ( 2 {p}_{1} + {p}_{2} - 1 ) - 2 c}$$

calculating a length of the first diagonal brace 12 as 1, in which the formulas are as follows:
a length of the second diagonal brace 22:
when the Poisson's ratio of the cell is negative in the radial direction:

$${l}_{1}^{′} = \sqrt{{( ( {R}_{2} - {R}_{1} ) / 2 - 2 a )}^{2} + {[ h ( {p}_{1} + {p}_{2} / 2 - 0.5 ) - c ]}^{2}}$$

when the Poisson's ratio of the cell is positive in the radial direction:

$${l}_{1}^{′} = \sqrt{{( ( {R}_{2} - {R}_{1} ) / 2 - 2 a )}^{2} + {[ h ( 0.5 - {p}_{3} - {p}_{4} / 2 ) + c ]}^{2}}$$

a length of the first diagonal brace 12 of the inner ring of the cell:

$${l}_{2}^{′} = 2 {R}_{1} sin ( \frac{θ}{4} - b ) / sin {φ}_{2}$$

a length of the third diagonal brace 32:

$${l}_{3}^{′} = ( {R}_{1} + {R}_{2} ) sin ( \frac{θ}{4} - b ) / sin {φ}_{3}$$

a length of the first diagonal brace 12 of the outer ring of the cell:

$${l}_{4}^{′} = 2 {R}_{2} sin ( \frac{θ}{4} - b ) / sin {φ}_{4}$$

according to the calculation formula of the Poisson's ratio:

$$v = - \frac{h / 2}{( l sin φ + 2 a ) tan φ}$$

substituting

$${l}_{1}^{′}$$

and φ₁ as a group,

$${l}_{2}^{′}$$

and φ₂ as a group,

$${l}_{3}^{′}$$

and p₃ as a group,

$${l}_{4}^{′}$$

and φ₄ as a group into l and p of the calculation formula of the Poisson's ratio, respectively, to obtain the Poisson's ratios of the cell in the circumferential direction and the radial direction;
where R₁ denotes an inner diameter of the cell bounding box, R₂ denotes an outer diameter of the cell bounding box, θ denotes a central angle of the cell bounding box, p₁*h denotes a length of the connecting rod, p₂*h denotes a length of the first vertical rod on the circumferential unit extending in the circumferential direction of the cell, p₃*h denotes a vertical distance from the top of the connecting rod to the bottom of the first diagonal brace, p₄*h denotes a length of the first vertical rod on the circumferential unit extending in the radial direction of the cell, S denotes the cross-sectional area of the third vertical rod, c denotes a height of the first diagonal brace or the second diagonal brace.

The calculation formula of the Poisson's ratio can be derived in the following manner.

When a cell with a square cross section is subjected to a force F_{y} in the vertical direction, the strain εₓ in the horizontal direction and the strain ε_{y} in the vertical direction of the cell with a square cross section are calculated as follows:

$${ε}_{x} = \frac{2 {Δ}_{x}}{2 l sin φ + 4 a}$$

$${ε}_{y} = \frac{2 {Δ}_{y}}{h}$$

where

$${Δ}_{x} = \frac{2 {F}_{y} {l}^{3} sin φ cos φ}{3 E I} , {Δ}_{y} = \frac{2 {F}_{y} {l}^{3} {sin}^{2} φ}{3 EI} ,$$

h denotes a height of a cell with a square cross section, φ denotes an included angle between the diagonal brace and the vertical rod in the cell with a square cross section, l denotes a length of the diagonal brace in the cell with a square cross section, and C denotes a height of the diagonal brace in the cell with a square cross section.

According to the Poisson's ratio ν=−εₓ/ε_{y}, the calculation formula of the Poisson's ratio is obtained as follows:

$$v = - \frac{h / 2}{( l sin φ + 2 a ) tan φ}$$

It can be known from the calculation formula of the Poisson's ratio that, when h and l are unchanged, if φ>90°, ν>0; and if φ<90°, ν<0.

### Embodiment 4

This embodiment provides four porous tube cells and porous tube structures.

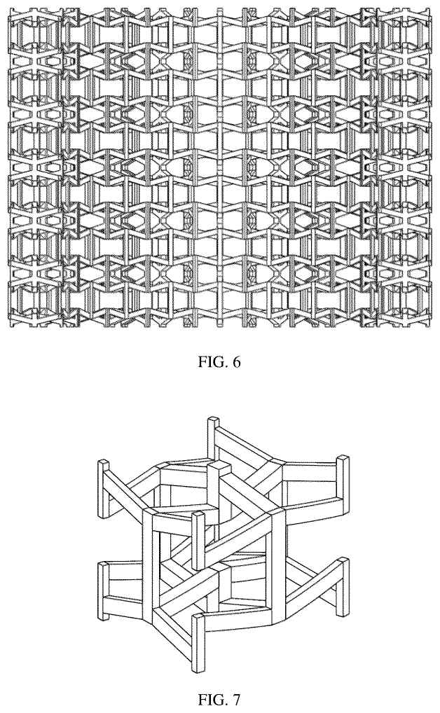

The first porous tube structure is shown in FIG. 5 and FIG. 6 with a radial Poisson's ratio of 0.25 and a circumferential Poisson's ratio of −0.2. The overall sizes of the porous tube structure are 80 mm in outer diameter, 70 mm in inner diameter and 60 mm in height. The number of the cells is 20×6. The porous tube structure includes the porous tube cell in FIG. 7 with a radial Poisson's ratio of 0.25 and a circumferential Poisson's ratio of −0.2.

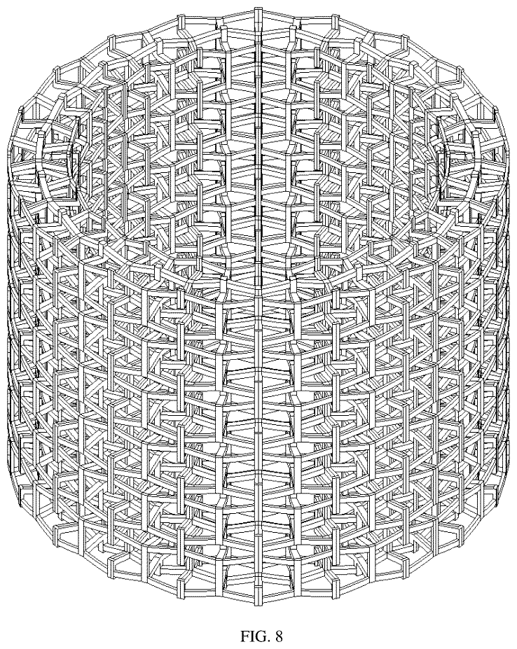

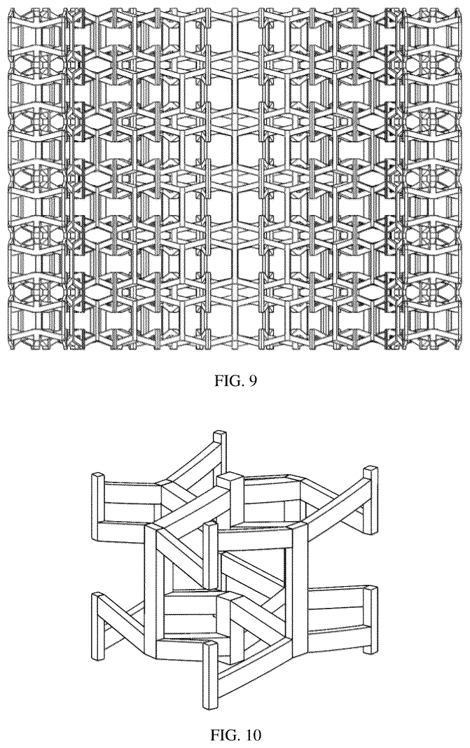

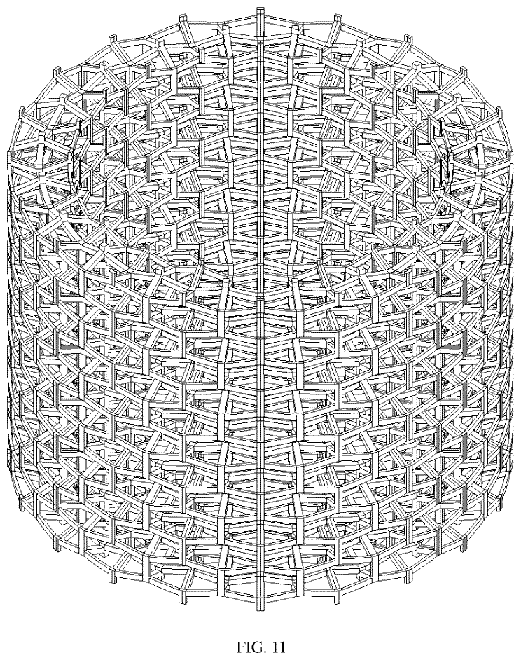

The second porous tube structure is shown in FIG. 8 and FIG. 9 with a radial Poisson's ratio of −0.25 and a circumferential Poisson's ratio of 0.2. The overall sizes of the porous tube structure are 80 mm in outer diameter, 70 mm in inner diameter and 60 mm in height. The number of the cells is 20×6. The porous tube structure includes the porous tube cell in FIG. 10 with a radial Poisson's ratio of −0.25 and a circumferential Poisson's ratio of 0.2.

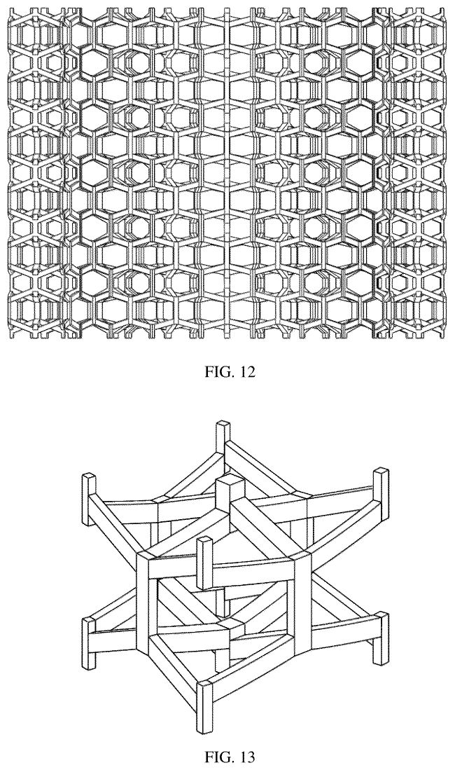

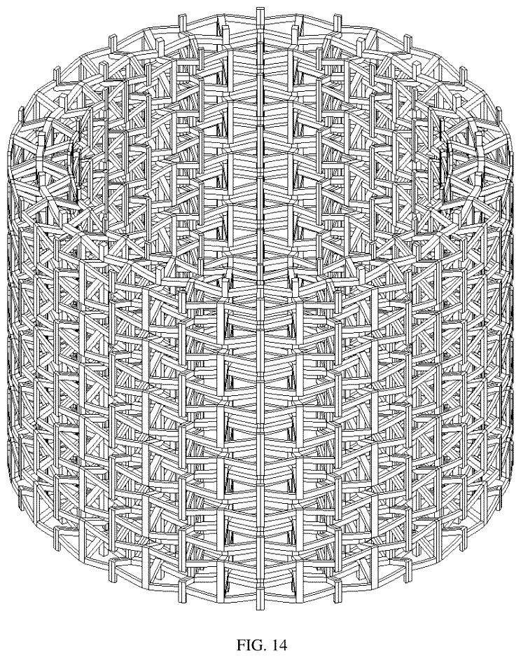

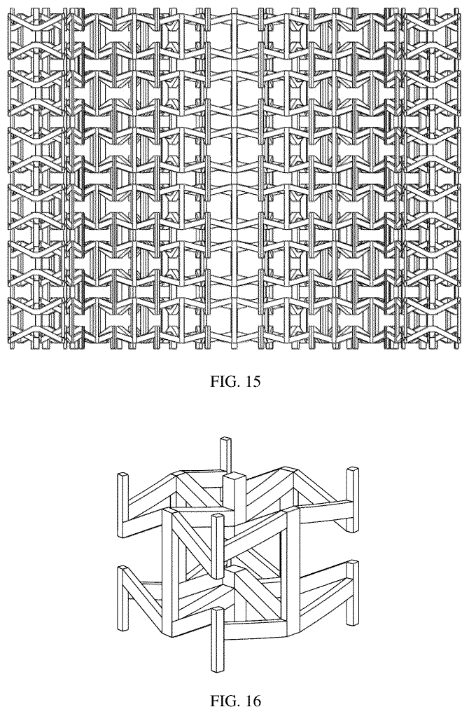

The third porous tube structure is shown in FIG. 11 and FIG. 12 with a radial Poisson's ratio of 0.4 and a circumferential Poisson's ratio of 0.2. The overall sizes of the porous tube structure are 80 mm in outer diameter, 70 mm in inner diameter and 60 mm in height. The number of the cells is 20×6. The porous tube structure includes the porous tube cell in FIG. 13 with a radial Poisson's ratio of 0.4 and a circumferential Poisson's ratio of 0.2.

The fourth porous tube structure is shown in FIG. 11 and FIG. 12 with a radial Poisson's ratio of −0.25 and a circumferential Poisson's ratio of −0.4. The overall sizes of the porous tube structure are 80 mm in outer diameter, 70 mm in inner diameter and 60 mm in height. The number of the cells is 20×6. The porous tube structure includes the porous tube cell in FIG. 16 with a radial Poisson's ratio of −0.25 and a circumferential Poisson's ratio of −0.4.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the detailed description and the application scope for those skilled in the art. To sum up, the contents of the specification should not be construed as limiting the present disclosure.

What is claimed is:

1. A porous tube cell, comprising two circumferential structures, two radial structures, an intermediate structure and a plurality of connecting rods, wherein each of the two circumferential structures comprises a plurality of circumferential units, each of the plurality of the circumferential units comprises a first vertical rod and four first diagonal braces, the four first diagonal braces are arc-shaped rods, one end of the first vertical rod is fixedly connected with one end of each of two of the four first diagonal braces, and an other end of the first vertical rod is fixedly connected with one end of each of other two of the four first diagonal braces; each of the two radial structures comprises a plurality of radial units, each of the plurality of radial units comprises a second vertical rod and four second diagonal braces, one end of the second vertical rod is fixedly connected with one end of each of two of the four second diagonal braces, and an other end of the second vertical rod is fixedly connected with one end of each of other two of the four second diagonal braces; the intermediate structure comprises a plurality of intermediate frames arranged in sequence in a vertical direction, each of the plurality of intermediate frames comprises a third vertical rod, two third diagonal braces and two fourth diagonal braces, one end of each of the two third diagonal braces and one end of each of the two fourth diagonal braces are fixedly connected with the third vertical rod; one of the two circumferential structures, one of the two radial structures, another one of the two circumferential structures and another one of the two radial structures are arranged in sequence around the intermediate structure and connected by the plurality of connecting rods to form a frame structure, each of the plurality of circumferential units forms an inner ring and an outer ring of the frame structure, each of the plurality of radial units extends in a radial direction of the frame structure, a projection of the frame structure on a plane perpendicular to the first vertical rod in a vertical direction is an annular sector, an end of each of the two third diagonal braces away from the third vertical rod is fixedly connected with the second vertical rod, an end of each of the two fourth diagonal braces away from the third vertical rod is fixedly connected with the first vertical rod, and one end of each of the plurality of connecting rods is fixedly connected with an end of a corresponding one of the four first diagonal braces away from the first vertical rod, and an other end of each of the plurality of connecting rods is fixedly connected with an end of a corresponding one of the four second diagonal braces away from the second vertical rod; an angle between each of the four first diagonal braces and the first vertical rod is different from an angle between each of the four second diagonal braces and the second vertical rod, and an angle between each of the two third diagonal braces and the third vertical rod is different from an angle between each of the two fourth diagonal braces and the third vertical rod.

2. The porous tube cell according to claim 1, wherein an included angle between two of the four first diagonal braces connected with a same end of the first vertical rod is ≥120° and <180°, or >180° and ≤240°, and an included angle between two of the four second diagonal braces connected with a same end of the second vertical rod is ≥120° and <180°, or >180° and ≤240°.

3. The porous tube cell according to claim 1, wherein the plurality of intermediate frames comprise two intermediate frames.

4. A porous tube structure, comprising a plurality of circular tube assemblies, wherein each of the plurality of circular tube assemblies comprises a plurality of the porous tube cells according to claim 1, each of the porous tube cells is fixedly connected in sequence along a circumferential trajectory in a horizontal plane, and the plurality of circular tube assemblies are fixedly connected in sequence in a vertical direction.

5. A method for designing a porous tube structure, comprising following steps:
step 1, determining an overall size of the porous tube structure and a number of cells, and determining a size and a number of cell bounding boxes according to the overall size of the porous tube structure;
step 2, adjusting an angle between first vertical rod and first diagonal brace, an angle between a third diagonal brace and a third vertical rod, an angle between a second diagonal brace and a second vertical rod, and an angle between a fourth diagonal brace and a third vertical rod in the cells;
step 3, calculating a poisson's ratio of the cells in a circumferential direction and a radial direction;
step 4, arranging the cells to obtain the porous tube structure.

6. The method for designing the porous tube structure according to claim 5, wherein the step 1 further comprises: after determining the overall size of the porous tube structure, determining geometric parameters of each of the cell bounding boxes according to following formulas:
a radial thickness of the cell bounding box: T=(R−r)/Nᵣ;
an inner diameter of the cell bounding box:
$${R}_{1} = r + {\sum }_{i = 1}^{{N}_{r}} T ( i - 1 ) ;$$
an outer diameter of the cell bounding box:
$${R}_{2} = r + {\sum }_{i = 1}^{{N}_{r}} Ti ;$$
a central angle of the cell bounding box: θ=2π/N_{τ};
a height of the cell bounding box: h=H/N_{z};
wherein N_{τ} denotes a number of the cells in a circumferential direction of the porous tube structure, N_{τ} denotes a number of the cells in a radial direction of the porous tube structure, R denotes an outer diameter of the porous tube structure, r denotes an inner diameter of the porous tube structure, N_{z} denotes a number of stacked layers of the cells in an axial direction of the porous tube structure, H denotes a height of the porous tube structure, and i denotes an i-th layer of the cells in the radial direction of the porous tube structure.

7. The method for designing the porous tube structure according to claim 6, wherein the step 2 further comprises: setting cross-sectional shapes of the first vertical rod, the second vertical rod, the third vertical rod and a connecting rod perpendicular to the respective length directions to be square, and keeping a relative position between a geometric center of the first vertical rod and a geometric center of the first diagonal brace unchanged, and a relative position between a geometric center of the second vertical rod and a geometric center of the second diagonal brace unchanged;
obtaining the geometric parameters of the cell bounding box based on the step 1 according to following formulas;
a distance between the second vertical rod and the connecting rod:
$$\frac{{R}_{1} - {R}_{2} - 4 a}{2} ;$$
an arc length between the first vertical rod and the connecting rod on a circumferential unit of an inner ring of each cell:
$$\frac{θ π {R}_{1}}{360} - 2 b ;$$
an arc length between the first vertical rod and the connecting rod on a circumferential unit of an outer ring of the cell:
$$\frac{θ π {R}_{2}}{360} - 2 b ;$$
a width of the third diagonal brace in the radial direction of the cell: 2a=c=\sqrt{S};
an arc length of an end of the fourth diagonal brace located at the outer ring of the cell in the circumferential direction of the outer ring of the cell:
$$2 b = \frac{4 a}{{R}_{1} + {R}_{2}} ;$$
defining 2p₁=p₂=p₄; and
$$\frac{c}{h} < {p}_{3} < {p}_{1} ;$$
wherein R₁ denotes the inner diameter of the cell bounding box, R₂ denotes the outer diameter of the cell bounding box, θ denotes the central angle of the cell bounding box, S denotes a cross-sectional area of the third vertical rod, a denotes a width of the first diagonal brace in the radial direction of the cell, b denotes an arc length of an end of the first diagonal brace in the circumferential direction of the cell, c denotes a height of the first diagonal brace or the second diagonal brace, p₁, p₂, p₃ and p₄ are coefficients.

8. The method for designing the porous tube structure according to claim 7, wherein the step 3 further comprises:
calculating an included angle as φ, in which formulas are as follows:
an angle between the second diagonal brace and the second vertical rod:
$${φ}_{1} = {tan}^{- 1} \frac{( {R}_{2} - {R}_{1} ) - 4 a}{h ( 2 {p}_{3} + {p}_{4} - 1 ) - 2 c}$$
an angle between the first diagonal brace and the first vertical rod on the circumferential unit of the inner ring of the cell:
$${φ}_{2} = {tan}^{- 1} \frac{2 {R}_{1} sin ( \frac{θ}{2} - 2 b )}{h ( 2 {p}_{1} + {p}_{2} - 1 ) - 2 c}$$
an angle between the third diagonal brace and the second vertical rod:
$${φ}_{3} = {tan}^{- 1} \frac{( {R}_{1} + {R}_{2} ) sin ( \frac{θ}{2} - 2 b )}{h ( 2 {p}_{1} + {p}_{2} - 1 ) - 2 c}$$
an angle between the first diagonal brace and the first vertical rod on the circumferential unit of the outer ring of the cell:
$${φ}_{4} = {tan}^{- 1} \frac{2 {R}_{2} sin ( \frac{θ}{2} - 2 b )}{h ( 2 {p}_{1} + {p}_{2} - 1 ) - 2 c}$$
calculating a length of the first diagonal brace as 1, in which formulas are as follows:
a length of the second diagonal brace:
when the Poisson's ratio of the cell is negative in the radial direction:
$${l}_{1}^{′} = \sqrt{{( ( {R}_{2} - {R}_{1} ) / 2 - 2 a )}^{2} + {[ h ( {p}_{1} + {p}_{2} / 2 - 0.5 ) - c ]}^{2}}$$
when the Poisson's ratio of the cell is positive in the radial direction:
$${l}_{1}^{′} = \sqrt{{( ( {R}_{2} - {R}_{1} ) / 2 - 2 a )}^{2} + {[ h ( 0.5 - {p}_{3} - {p}_{4} / 2 ) + c ]}^{2}}$$
a length of the first diagonal brace of the inner ring of the cell:
$${l}_{2}^{′} = 2 {R}_{1} sin ( \frac{θ}{4} - b ) / sin {φ}_{2}$$
a length of the third diagonal brace:
$${l}_{3}^{′} = ( {R}_{1} + {R}_{2} ) sin ( \frac{θ}{4} - b ) / sin {φ}_{3}$$
a length of the first diagonal brace of the outer ring of the cell:
$${l}_{4}^{′} = 2 {R}_{2} sin ( \frac{θ}{4} - b ) / sin {φ}_{4}$$
according to a calculation formula of the Poisson's ratio:
$$v = - \frac{h / 2}{( l sin φ + 2 a ) tan φ}$$
substituting
$${l}_{1}^{′}$$
and φ₁ as a group,
$${l}_{2}^{′}$$
and φ₂ as a group,
$${l}_{3}^{′}$$
and φ₃ as a group,
$${l}_{4}^{′}$$
and φ₄ as a group into l and φ of the calculation formula of the Poission's ratio, respectively, to obtain the Poisson's ratio of the cell in the circumferential direction and the radial direction;
where R₁ denotes the inner diameter of the cell bounding box, R₂ denotes the outer diameter of the cell bounding box, θ denotes the central angle of the cell bounding box, p₁*h denotes a length of the connecting rod, p₂*h denotes a length of the first vertical rod on the circumferential unit extending in the circumferential direction of the cell, p₃*h denotes a vertical distance from a top of the connecting rod to a bottom of the first diagonal brace, p₄*h denotes a length of the first vertical rod on the circumferential unit extending in the radial direction of the cell, S denotes the cross-sectional area of the third vertical rod, c denotes a height of the first diagonal brace or the second diagonal brace.

9. A porous tube structure, comprising a plurality of circular tube assemblies, wherein each of the plurality of circular tube assemblies comprises a plurality of the porous tube cells according to claim 2, each of the porous tube cells is fixedly connected in sequence along a circumferential trajectory in a horizontal plane, and the plurality of circular tube assemblies are fixedly connected in sequence in a vertical direction.

10. A porous tube structure, comprising a plurality of circular tube assemblies, wherein each of the plurality of circular tube assemblies comprises a plurality of the porous tube cells according to claim 3, each of the porous tube cells is fixedly connected in sequence along a circumferential trajectory in a horizontal plane, and the plurality of circular tube assemblies are fixedly connected in sequence in a vertical direction.
